(19) United States
(12) Patent Application Publication
(10) Pub. No.: US 2006/0051068 A1
(43) Pub. Date: Mar. 9, 2006

(54) Decoder apparatus and method for smoothing artifacts created during error concealment

(75) Inventor: Cristina Gomila, Princeton, NJ (US)

Correspondence Address: THOMSON LICENSING INC., PATENT OPERATIONS, PO BOX 5312, PRINCETON, NJ, 08543-5312, US

(73) Assignee: THOMSON Licensing S.A., Boulogne-Billancourt (FR)

(21) Appl. No.: 10/541,782

(22) PCT Filed: Jul. 9, 2003
(86) PCT No.: PCT/US03/21329

§ 371 Date: Jul. 11, 2005

Related U.S. Application Data
(60) Provisional application No. 60/439,312, filed on Jan. 10, 2003.

(51) Int. Cl. H04N 5/76; H04N 5/781

(52) U.S. Cl. 386/114; 386/116

(57) ABSTRACT

Errors in coded macroblocks are concealed during decoding by way of an error concealment stage present in a decoder. Error-concealed macroblocks produced by the error concealment stage undergo deblocking filtering by a deblocking filter before being output by the decoder to avoid the spread of erroneous pixel values. The error concealment stage controls the deblocking filter in accordance with the error concealment technique to vary the strength of the deblocking filter to force maximum strength on transitions artificially created by the recovery of lost macroblocks.

### CROSS REFERENCE TO RELATED APPLICATION

This application claims priority under 35 U.S.C. 119(e) to U.S. Provisional Patent Application Ser. No 60/439,312, filed Jan. 10, 2003, the teachings of which are incorporated herein.

### TECHNICAL FIELD

This invention relates to a video decoder that performs error concealment to mitigate errors caused by missing or corrupted data.

### BACKGROUND ART

In many instances, video streams undergo compression (coding) to facilitate storage and transmission. Not infrequently, such coded video streams incur data losses or become corrupted during transmission because of channel errors and/or network congestion. Upon decoding, the loss/corruption of data manifests itself as missing pixel values. To reduce artifacts attributable to such missing/corrupted pixel values, a decoder will “conceal” such missing/corrupted pixel values by estimating the values from other macroblocks in the same image or from another image. The term conceal is a somewhat of a misnomer because the decoder does not actually hide missing or corrupted pixel values.

Despite the importance of error concealment, most decoders usually implement only the simplest and fastest concealment algorithms for real-time applications. For most real-time applications, there exist two different approaches for achieving error concealment. One approach proposes the replacement of the missing macroblock by copying one of its correctly decoded neighbors. This approach finds application on low quality systems given that the blocking artifacts appearing on the reconstructed image are highly visible. The second approach attempts to smooth the blocking artifacts by interpolating the content of the missing macroblock based on the pixel values on the border of correctly decoded neighboring macroblocks. Two different schemes fit into this latter category: (1) replacement of all the pixels within a macroblock/block with a common mean value; and (2) replacement of each pixel value by means of a weighted prediction based on the pixel distance to the macroblock/block boundaries. With no criteria to distinguish between flat and contoured regions, this concealment approach tends to blur the reconstructed image creating the opposite artifact.

Thus, there is need for a concealment approach that achieves simplicity and high performance when reducing the blocking artifacts created by the derivation process of the missing/corrupted pixel values.

### BRIEF SUMMARY OF THE INVENTION

Briefly, in accordance with a preferred embodiment of the present principles, a video decoder compliant with the ISO/ITU H.264 video compression standard includes an error concealment stage for concealing errors in decoded macroblocks that have missing/corrupted pixel values. The error concealment stage performs such error concealment by estimating the missing/corrupted pixel values from previously transmitted macroblocks that are error free. The macroblocks produced by the error concealment stage are input to a deblocking filter in the decoder that deblocks transitions artificially created by the inaccuracy of the error concealment process. In other words, the error concealment stage performs error concealment in advance of filtering by the deblocking filter. Advantages of such approach are twofold. First, by using the deblocking filter to enhance the results of the error concealment method, high quality can be achieved with low complexity requirements. Secondly, error correction prior deblocking avoids the spread erroneous pixel values when attempting to smooth transitions between erroneous and correctly decoded blocks.

In accordance with another aspect of the present principles, the error concealment stage varies the parameters of the deblocking filter. In particular, the error concealment stage varies the parameters of the deblocking filter to force maximum filter strength on the transitions artificially created by the recovery of lost macroblocks.

### BRIEF DESCRIPTION OF THE DRAWINGS

FIG. 1 depicts a block schematic diagram of a decoder that provides error concealment in accordance with the present principles; and

FIG. 2 depicts in flow chart form the process by which the decoder of FIG. 1 operates to accomplish error concealment.

### DETAILED DESCRIPTION

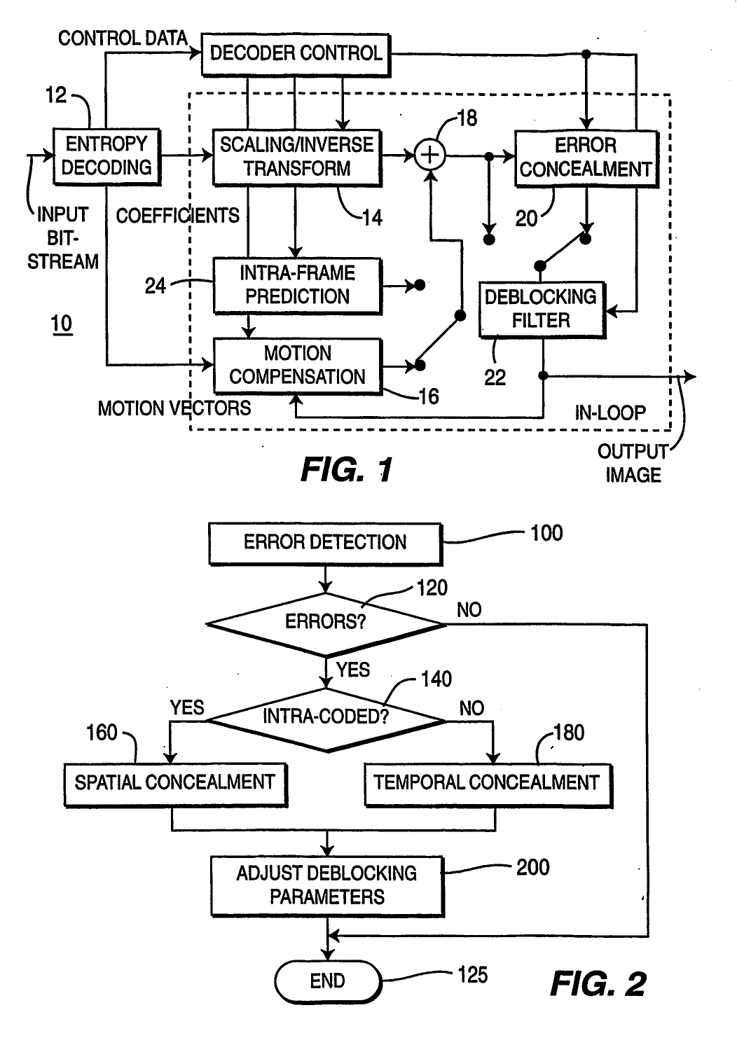

FIG. 1 illustrates a block schematic diagram of a video decoder 10 compliant with the ISO/ITU H.264 compression standard for accomplishing error concealment in accordance with the present principles. The decoder 10 includes an entropy decoding stage 12 that receives an input bit stream representative of a video signal compressed (encoded) by an upstream encoder (not shown) in accordance with the H.264 compression standard. The entropy decoding stage 12 decodes the input stream to yield: (a) transformed coefficients, (b) motion vectors and reference frame indices, and (c) control data A scaling/inverse transformation stage 14 receives the transformed coefficients for inverse transformation and scaling to re-create the prediction error. The prediction error reflects the difference between the original image at the encoder and the estimated image the decoder can obtain based on previously transmitted data. The prediction error produced by the scaling/inverse transformation stage 14 passes to a summing block 18 for summing with the estimated image obtained either by inter or intra-prediction.

For an input macroblock encoded in inter prediction mode, the motion compensation stage 16 serves to produce the estimated image, from input information including the motion vectors and the reference frame indices sent in the input bit-stream and corresponding reference frames previously stored in the decoder buffer. The output from the motion compensation stage 16 passes to the summing block 18 for summing with the error prediction produced by the scaling/inverse transform stage 14 to produce the reconstructed image. Each macroblock in the reconstructed image output from the summing block 18 passes to an error concealment stage 20, which detects whether the macroblock has missing or corrupted pixel values. If so, the error concealment stage 20 will substitute estimated pixel values in place of those that are lost or corrupted. The error-concealed macroblock output by the error concealment stage 20 undergoes deblocking at deblocking filter 22. In accordance with the present principles, the deblocking filter 22 has adjustable parameters to allow varying of the strength of the filtering performed on the concealed image. The deblocking filter 22 produces the output image of the decoder 10. At this point, those images marked as reference images in the bit-stream are stored in the reference frame buffer to serve as one of the inputs to the motion compensation block 16.

For input macroblocks encoded in intra prediction mode, the intra-prediction stage 24 will produce the estimated image in accordance with the intra-prediction modes sent on the coded input bit-stream. The estimated image produced by the intra-prediction stage 24 passes to the summing block 18 for summing with the error prediction produced by the scaling/inverse transform stage 14 to produce the reconstructed image. Each inter-predicted macroblock output by the summing block 18, like each intra predicted macroblock output by the summing block, undergoes error concealment at the error concealment stage 20 and then deblocking by the deblocking filter 22.

FIG. 2 illustrates in flow chart form the steps undertaken by the error concealment stage 20 within the decoder 10 of FIG. 1 to accomplish error concealment and to adjust the parameters of the deblocking filter 22 to achieve maximum filtering on the transitions resulting from error concealment. The error concealment stage 20 initiates error concealment during step 100 of FIG. 2 by performing error detection on each successive input macroblock received from the summing block 18 of FIG. 1. Upon detecting no error during step 120, then the error concealment stage ends the error concealment process (step 125 of FIG. 2) and outputs the received macroblock to the deblocking filter to 22 with no corrections. In the absence of making any error concealment to the received macroblock, the error concealment stage makes no adjustment to the parameters of the deblocking filter 22 of FIG. 1.

Should an error exist, as determined during step 120, the error concealment stage 20 of FIG. 1 makes a determination during step 140 of FIG. 2 whether the macroblock received from the summing block 18 of FIG. 1 has been intra-coded. An intra-coded block having errors undergoes spatial error concealment during step 160, whereas an inter-coded block undergoes temporal concealment during step 180.

There exist various techniques for spatial error concealment, including:
Block copy (BC)

With this approach, the replacement of a missing/corrupted macroblock is obtained from one of its correctly decoded neighbors.
Pixel Domain Interpolation (PDI):

The missing/corrupted macroblock data is interpolated from the pixel values at the border of the correctly decoded neighbors. Two different approaches exist for accomplishing PDL For example, all the pixels within a macroblock can be interpolated to a common mean value. Alternatively, each pixel value is obtained by means of a weighted prediction based on the pixel distance to the macroblock boundaries.
Multi-Directional Interpolation (MDI)

The multi-directional interpolation technique constitutes an improved version of the PDI technique because the MDI technique provides interpolation along the edge directions. Accomplishing MDI requires estimating the directions of the main contours in the neighborhood of the missing/corrupted pixel value prior to directional interpolation.
Maximally Smooth Recovery (MSR):

In the Discrete Cosine Transformation (DCT) domain, low frequency components are used for error concealment to provide a smooth connection with the adjacent pixels. When data-partitioning encoding is used, the MSR technique exploits the correctly received DCT coefficients instead of discarding all the data within the corrupted macroblock/block.
Projection On Convex Sets (POCS):

In accordance with this technique, adaptive filtering is performed in the Fast Fourier Transform (FFT) domain, based on the classification of a larger region surrounding the macroblock with missing/corrupted pixel values. Such adaptive filtering includes the application of low-pass filtering on smooth regions while applying an edge filter on sharp regions. This procedure includes a filtering iteration and several a priori constraints will apply to the treated image.

In addition to the foregoing techniques, spatial error concealment can be advantageously achieved the following manner. For each identified macroblock, at least one intra-prediction mode is derived from neighboring macroblocks. When the image is coded in accordance with the ISO/ITU H.264 video compression standard, two intra-coding types are available for the coding of each macroblock: (1) for an Intra_{—}16×16 type, a single intra prediction mode is derived for the whole macroblock; (2) for an Intra_{—}4×4 type, an intra prediction mode is derived for each sub-macroblock of 4×4 pixels within the macroblock. (In this case, there are sixteen intra prediction modes per coded macroblock.). The derived intra-prediction modes are then applied to generate the missing pixel values. The process by which the derived intra prediction modes are applied to estimate missing or corrupted pixel values corresponds to the derivation process employed during decoding to estimate (predict) the non-coded values to reduce the coding effort. In other words, the present technique utilizes the intra prediction mode information normally used in coding for spatial error concealment purposes. When the coded data referring to a particular macroblock is lost or corrupted, the intra prediction modes derived from neighboring macroblocks can provide important information about which is the best interpolation direction for spatial error concealment. Using such intra prediction modes for spatial error concealment yields significantly better performance than the classical spatial error concealment techniques with similar complexity.

In contrast to spatial error concealment, temporal concealment attempts the recovery of the coded motion information, namely the reference picture indices and the motion vectors, to estimate the missing pixel values from a previously transmitted macroblock. Recovery of the prediction error from the same macroblock is unfeasible since this information is coded without redundancy. Unlike spatial concealment, fundamentals of temporal concealment are almost the same in most of the published algorithms. Because it is computationally expensive to search for a missing motion vector of a missing macroblock in one or more reference frames, typically only a limited set of candidates is considered. Possible motion vectors for consideration include:
Zero motion: assumes that the lost block hasn't changed its location between two consecutive frames and performs the temporal concealment by simply copying the collocated block on the previous frame.
Global motion: assumes that the lost block undergoes a global motion, and that can be correctly approximated in most of the cases by estimating the camera motion parameters.
Local motion: assumes that the motion of spatially neighboring blocks is highly correlated and hence the motion of a missing block can be recovered from the local motion information available on its neighborhood.

Following either spatial error concealment during step 160 or temporal concealment during step 180, the error concealment stage 20 of FIG. 1 adjusts the parameters of the deblocking filter 22 of FIG. 1 to force maximum strength filtering on the transitions artificially created by the recovery of lost macroblocks. As defined by the H.264 standard, the intensity of the deblocking filter 22 adapts to the characteristics of each edge between blocks of 4×4 pixels. Adaptation is done depending on the following parameters:
The boundary strength value (Bs), computed at the decoder 10.
The Quantization Parameter (QP) average computed at the decoder 10 between any pair of blocks affected by the deblocking filter 22.
The filter offsets A and B transmitted in the slice header.

The boundary strength value, ranging from 0 to 4, designates the strength of the filtering that applies to the edge between two 4×4 pixel blocks. When Bs=0, the edge remains unfiltered. When Bs=4, the edge is smoothed by the strongest filter strength. The other parameters, namely the QP average and the filter offsets A and B, are jointly used to determine the thresholds that differentiate real contours from artificial transitions. High values of these parameters increase the number of filtered transitions.

In accordance with the present principles, the chosen error concealment algorithm will vary the boundary strength value, or any of the input parameters that, after computation, return the desired boundary strength value. Alteration of the boundary strength value can be done on the edges between pairs of concealed blocks and/or on the edges between the concealed blocks and correctly received ones. Ultimately whether it is appropriate or not to increase the strength of the deblocking filter and by what value depends on the particular technique chosen for error concealment.

In an illustrative embodiment, the maximal boundary strength value of (4) was chosen on the edges between pairs of blocks concealed independently. The particular error concealment technique could also change the value of the QP average between any pair of blocks and/or the offset values transmitted on the header of the corrupted slice. Changing the value of the QP average will increase the number of filtered transitions. In the illustrative embodiment, all parameters are forced to their maximal value, i.e. 51 for the QP average and 6 for the offsets A and B.

The foregoing describes a technique for accomplishing error concealment in a H.264 compliant decoder and for altering the strength of deblocking in accordance with the type of error concealment performed.

1. In combination with an ISO/ITU H.264 compliant video decoder containing a deblocking filter,
an error concealment stage that receives decoded macroblocks for concealing errors in macroblocks having missing/corrupted data by estimating their pixel values from previously transmitted macroblocks to yield error concealed macroblocks for input to the deblocking filter which by deblocking the error concealed macroblocks avoids the spread of erroneous pixel values.

2. The decoder according to claim 1 wherein the error concealment stage varies the strength of the deblocking performed by the deblocking filter in accordance with error concealment.

3. The decoder according to claim 2 wherein the error concealment stage modifies the strength of the deblocking filter by modifying a boundary strength value on transitions between concealed macroblocks and error-free (correctly received) macroblocks.

4. The decoder according to claim 2 wherein the error concealment stage modifies the strength of the deblocking filter by modifying a boundary strength value on transitions between pairs of concealed macroblocks.

5. The decoder according to claim 2 wherein the error concealment stage modifies a Quantization Parameter (QP) average for the deblocking filter between concealed macroblocks and correctly received macroblocks.

6. The decoder according to claim 2 wherein the error concealment stage modifies a Quantization Parameter (QP) average for the deblocking filter between pairs of concealed macroblocks.

7. The decoder according to claim 3 wherein the error concealment stage modifies a Quantization Parameter (QP) average for the deblocking filter between concealed macroblocks and correctly received macroblocks.

8. The decoder according to claim 4 wherein the error concealment stage modifies a Quantization Parameter (QP) average for the deblocking filter between pairs of concealed macroblocks.

9. The decoder according to claim 2 wherein the error concealment stages varies each of a pair of offset values A and B for the deblocking filter.

10. The decoder according to claim 9 wherein the error concealment stage modifies the strength of the deblocking filter by modifying a boundary strength value on transitions between concealed macroblocks and error-free (correctly received) macroblocks.

11. The decoder according to claim 9 wherein the error concealment stage modifies the strength of the deblocking filter by modifying a boundary strength value on transitions between pairs of concealed macroblocks.

12. The decoder according to claim 9 wherein the error concealment stage modifies a Quantization Parameter (QP) average for the deblocking filter between concealed macroblocks and correctly received macroblocks.

13. The decoder according to claim 9 wherein the error concealment stage modifies a Quantization Parameter (QP) average for the deblocking filter between pairs of concealed macroblocks.

14. The decoder according to claim 10 wherein the error concealment stage modifies a Quantization Parameter (QP) average for the deblocking filter between concealed macroblocks and correctly received macroblocks.

15. The decoder according to claim 10 wherein the error concealment stage modifies a Quantization Parameter (QP) average for the deblocking filter between pairs of concealed macroblocks.

16. A method for smoothing transitions in decoded macroblocks, comprising the steps of:
detecting if a decoded macroblock has errors attributable to missing/corrupted pixel values, and if so,
concealing errors by estimating the missing/corrupted pixel values from previously transmitted macroblocks to yield an error-concealed macroblock; and
filtering the error concealed-macroblock by a deblocking filter to smooth the transitions artificially created by the error concealment algorithm.

17. The method according to claim 16 further comprising the step of varying the strength of the deblocking performed by the deblocking filter in accordance with error concealment.

18. The method according to claim 17 wherein the step of modifying the strength of the deblocking filter comprises modifying a boundary strength value on transitions between concealed macroblocks and error-free (correctly received) macroblocks.

19. The method according to claim 17 wherein the step of modifying the strength of the deblocking filter comprises modifying a boundary strength value on transitions between pairs of concealed macroblocks.

20. The method according to claim 17 further comprising the step of modifying a Quantization Parameter (QP) average for the deblocking filter between concealed macroblocks and correctly received macroblocks.

21. The method according to claim 17 further comprising the step of modifying a Quantization Parameter (QP) average for the deblocking filter between pairs of concealed macroblocks.

22. The method according to claim 18 wherein the error concealment stage modifies a Parameter (QP) average for the deblocking filter between concealed macroblocks and correctly received macroblocks.

23. The method according to claim 18 further comprising the step of modifying a Quantization Parameter (QP) average for the deblocking filter between pairs of concealed macroblocks.

24. The method according to claim 17 further comprising the step of varying each of a pair of offset values A and B for the deblocking filter.
